(19) United States
(12) Patent Application Publication
(10) Pub. No.: US 2010/0278462 A1
(43) Pub. Date: Nov. 4, 2010

(54) Package With One or More Access Points For Breaking One or More Seals and Accessing the Contents of the Package

(75) Inventor: Leif B. Sorensen, Cape Canaveral, FL (US)

Correspondence Address: DORITY & MANNING, P.A., POST OFFICE BOX 1449, GREENVILLE, SC, 29602-1449, US

(73) Assignee: POPPACK, LLC, San Francisco, CA (US)

(21) Appl. No.: 12/434,254

(22) Filed: May 1, 2009

(51) Int. Cl. B65D 33/00; B31B 1/00

(52) U.S. Cl. 383/200; 493/267

(57) ABSTRACT

An easy to open package is described. The package includes a sealed compartment having a tab region. The tab region is formed by connecting together a first panel to a second panel. Within the tab region, however, are a pair of opposing peel tabs. The peel tabs comprise an area within the tab region where the first panel is not sealed to the second panel. The peel tabs extend from the tab region to an edge of the package. In this manner, a user can peel apart the peel tabs to separate the first panel from the second panel and open the sealed compartment. In one embodiment, at least one of the peel tabs can be coated with a material to prevent the first panel from sealing to the second panel.

### BACKGROUND

Many products, especially consumer products, are packaged in flexible bags made from a plastic or polymer film. Packages made from polymer films can offer various advantages. For instance, the polymer films can be wrapped tightly around the consumer products for eliminating void space. The resulting packages are not very bulky, are easy to handle, and can be easily stacked. The polymer films can also be translucent allowing a purchaser to view the contents prior to making the purchase. In addition, the polymer films can be printed with decorative graphics to make the product more attractive.

Although packages made from polymer films can provide various advantages, opening such packages can be quite difficult. For example, the polymer films must have sufficient strength to prevent against rupture during the packaging process and during subsequent transportation. Increasing the strength of the film or the seals that surround the content of the package, however, increases the difficulty in opening the package.

For example, many such packages, such as packages that contain cereals, potato chips, and the like, include no easy opening feature. Thus, brute force or scissors need to be used in order to open the package.

In other embodiments, in order to facilitate the opening of packages made from polymer films, the packages may include one or more lines of weakness or perforations where the package may be torn open by the consumer. Most perforation lines, however, are still very difficult to tear open.

In view of the above, a need currently exists for an opening device that facilitates the opening of packages, especially packages made from polymer films.

### SUMMARY

In general, the present disclosure is directed to a package for consumer products that contains an opening device for accessing the contents of the package. In one embodiment, the package can be made from one or more polymer films. In accordance with the present disclosure, the opening device comprises at least one pair of peelable flaps that extend to at least one edge of the package. The peelable flaps are formed in a tab portion of the package where two polymer films have been sealed together. The peelable tabs are formed by introducing a material, such as a coating, in between the two films to prevent the films from sealing together.

For example, in one embodiment, the present disclosure is directed to a package that includes a sealed compartment defined by at least a first panel spaced from a second panel. The first and second panels, for instance, may be made from polymer films. The package further includes a tab region where the first panel is sealed to the second panel.

In accordance with the present disclosure, the package further comprises at least one pair of opposing peel tabs located in the tab region. The package, for instance, can include only a single pair of peel tabs or can include multiple pairs. The peel tabs comprise an area within the tab region where the first panel is not sealed to the second panel. The peel tabs extend from the tab region to at least one edge of the package. In this manner, a user can peel apart the peel tabs to separate the first panel from the second panel and open the sealed compartment.

In one embodiment, the first panel is attached to the second panel in the tab region by a peel seal. As used herein, a “peel seal” refers to an attachment structure between the first panel and the second panel that is peelable meaning that the first panel can be peeled away from the second panel upon application of a suitable peel force.

The peel tabs can be formed in the peel seal by applying a coating to one of the panels that prevents the panels from sealing together. For instance, in one embodiment, the coating may comprise a silicone. The coating, for instance, can be printed on one of the panels during construction of the package. In one embodiment, the coating can have a different color than the first and/or second panels so that the peel tabs can be visually located by a user. In one embodiment, for instance, the coating may have any suitable color, while the panels may be translucent or transparent.

The peel tabs can have any suitable shape. In one embodiment, for instance, the peel tabs may have a rectangular-like shape. In this embodiment, three of the sides may comprise sealed portions of the tab region, while the final side may comprise the open edge of the package. In an alternative embodiment, the peel tabs may have a semi-circular-like shape. In this embodiment, the peel tabs may include a flat side that comprises the edge of the package.

In still another embodiment, peel tabs may surround a corner of the package. For instance, the peel tabs may have a circular-like shape that surrounds one of the corners of the package. In this manner, the peel tabs have a wedge-like shape.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a plan view of one embodiment of a package in accordance with the present disclosure;

FIG. 2 is an exploded view of the package illustrated in FIG. 1;

FIG. 3a is a partial side view, while FIG. 3b is a top view of the embodiment shown in FIG. 1;

FIG. 4a is another embodiment of an opening device made in accordance with the present disclosure;

FIG. 4b is a side view of the opening device illustrated in FIG. 4a being peeled back;

FIG. 5 is a partial side view of another embodiment of an opening device made in accordance with the present disclosure;

FIG. 6 is a partial side view of still another embodiment of an opening device made in accordance with the present disclosure; and

FIG. 7 is a partial side view of yet another embodiment of an opening device made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a package for consumer products that includes a unique opening device for opening the package. The package, in one embodiment, can be made from one or more polymer films. The walls of the package, for example, can be flexible. In the past, such packages have been relatively difficult to open. In accordance with the present disclosure, however, the package includes an opening device that comprises at least one pair of peelable tabs that are located along at least one edge of the package. The peelable tabs can each be peeled away from each other, causing the polymer films used to make the package to separate. The polymer films can be peeled away from each other until the package is opened and the contents are accessible.

In one embodiment, the package comprises two polymer films that are sealed together in a tab region. The peel tabs can be located in the tab region and can be created by “contaminating” one or both of the films so that the films will not seal together where the contamination occurs. The contaminated area can be created, for instance, by coating a material (such as by printing) in between the two prior films during construction of the package.

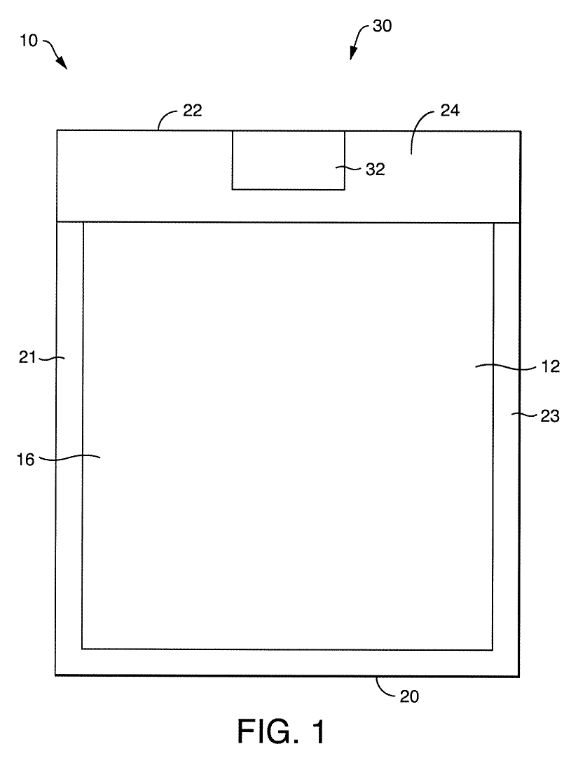

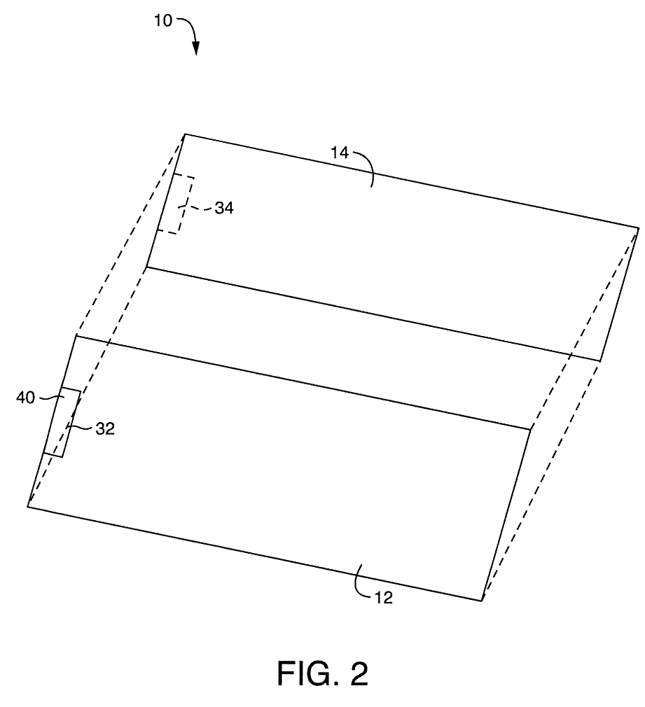

Referring to FIGS. 1 and 2, one embodiment of a package 10 made in accordance with the present disclosure is shown. FIG. 1 is a plan view of the package, while FIG. 2 is an exploded view. As shown in FIG. 2, the package 10, in this embodiment, includes a first panel 12 spaced from a second panel 14. Referring to FIG. 1, the panels 12 and 14 are sealed together to form a perimeter edge. A compartment 16 is formed in between the first panel 12 and the second panel 14. If desired, the package 10 can include various other panels. For instance, in one embodiment, the package can include side panels that may, for instance, increase the size of the compartment 16.

It should be understood that the package 10 can have any suitable shape depending upon various factors including the type of products contained in the package. In the embodiment illustrated in FIGS. 1 and 2, for instance, the package generally has a rectangular-like shape. The package 10, for instance, includes a bottom edge 20, a top edge 22 and a pair of side edges 21 and 23. As shown in FIG. 1, the top edge 22 is part of a tab region 24.

Each of the panels that comprise the package 10 as shown in FIG. 1 can generally be made from any suitable material. For instance, the package 10 can be made from paper, a fabric such as a woven or nonwoven material, or a film material. When made from film material, the package 10 can be made from any suitable polymer. Polymers that may be used to form the package include, for instance, polyolefins such as polyethylene and polypropylene, polyesters, polyamides, polyvinyl chloride, mixtures thereof, copolymers thereof, terpolymers thereof, and the like. In addition, the package can also be made from any suitable elastomeric polymer.

The material used to form the package 10 can comprise a single layer of material or can include multiple layers. For instance, when the package is made from a polymer film, the film can include a core layer of polymeric material coated on one or both sides with other functional polymeric layers. The other functional polymeric layers may include, for instance, a heat sealing layer for thermally bonding the film together at desired locations, an oxygen barrier layer, an ultraviolet filter layer, an anti-blocking layer, a printed layer, and the like.

When made from a polymer layer, the package 10 can be translucent or transparent. If translucent or transparent, for instance, the contents of the package can be viewed from the outside. In other embodiment, however, the package can be opaque. For instance, in one embodiment, the package 10 can display various graphics that identify, for instance, the brand and the description of the product inside.

In the embodiment illustrated in FIG. 1, the package 10 includes the sealed tab region 24 located at the top of the package. The top region 24 comprises an area where the first panel 12 has been sealed to the second panel 14.

In one embodiment, the first panel 12 is attached to the second panel 14 in the tab region 24 by a peel seal meaning that the first panel 12 can be peeled away from the second panel 14 by applying a sufficient peel force. The edge regions 21, 23 and 20 can also include a peel seal or can include a more permanent seal. When forming a more permanent bond, for example, in one embodiment, the edge regions 20, 21 and 23 may be formed through thermal bonds, ultrasonic bonds or may be adhesively secured together.

If the edge regions 20, 21 and 23 are permanently attached together, then the package 10 is opened by peeling apart the first panel from the second panel at the tab region to form an opening in the top of the compartment 16. If the edge regions 20, 21 and 23, however, also comprise peel seals then the first panel 12 can be peeled and completely removed from the second panel 14.

It should also be understood that the package 10 may not include sealed edge regions 20, 21 and 23 as shown. For instance, in other constructions, the package 10 can be made from a single piece of film folded on itself, thus eliminating one of the sealed edge regions on the side of the package or the sealed edge region at the bottom of the package. In still another embodiment, the package can be made from a tubular film such that the film only needs to be attached to itself at the bottom and at the top in order to form the compartment 16.

Various different methods and techniques can be used to form peel seals. For example, in one embodiment, the tab region 24 (and possibly the edge regions 20, 21, and 23) may include a first portion that is adhesively secured to a second portion along the seal. The first portion may be coated with a pressure sensitive adhesive. The adhesive may comprise, for instance, any suitable adhesive, such as an acrylate.

The second and opposing portion of the peel seal, on the other hand, may comprise a film coated or laminated to a release layer. The release layer may comprise, for instance, a silicone.

When using an adhesive layer opposite a release layer as described above, the seal is resealable after the package is opened.

In an alternative embodiment, each opposing portion of the peel seal may comprise a multi-layered film. The major layers of at least one film may comprise a supporting layer, a pressure sensitive adhesive component, and a thin contact layer. In this embodiment, the two portions of the peel seal can be brought together and attached. For instance, the thin contact layer of one film can be attached to the other film, such as to the thin contact layer of the opposing film, using heat and/or pressure. When the peel seal is peeled apart, a part of the sealed area of one of the contact layers tears away from its pressure sensitive adhesive component and remains adhered to the opposing contact layer. Thereafter, resealing can be affected by re-engaging this torn away contact portion with the pressure sensitive adhesive from which it was separated when the layers were peeled apart.

In this embodiment, the contact layer can comprise a film having a relatively low tensile strength and having a relatively low elongation at break. Examples of such materials include polyolefins such as polyethylenes, copolymers of ethylene and ethylenically unsaturated comonomers, copolymers of an olefin and an ethylenically unsaturated monocarboxylic acid, and the like. The pressure sensitive adhesive contained within the layers, on the other hand, may be of the hot-melt variety or otherwise responsive to heat and/or pressure.

In still another embodiment, the peel seal can include a combination of heat sealing and adhesive sealing. For instance, in one embodiment, the peel seal may comprise a first portion that is heat sealed to a second portion. Within the tab region may also exist a peel seal composition that may, in one embodiment, interfere with the heat sealing process to produce a breachable attachment. The peel seal composition, for instance, may comprise a lacquer.

In an alternative embodiment, an adhesive may be spot coated over the tab region.

The peel seal used in accordance with the present disclosure can be resealable as described above or can be for only a single time use.

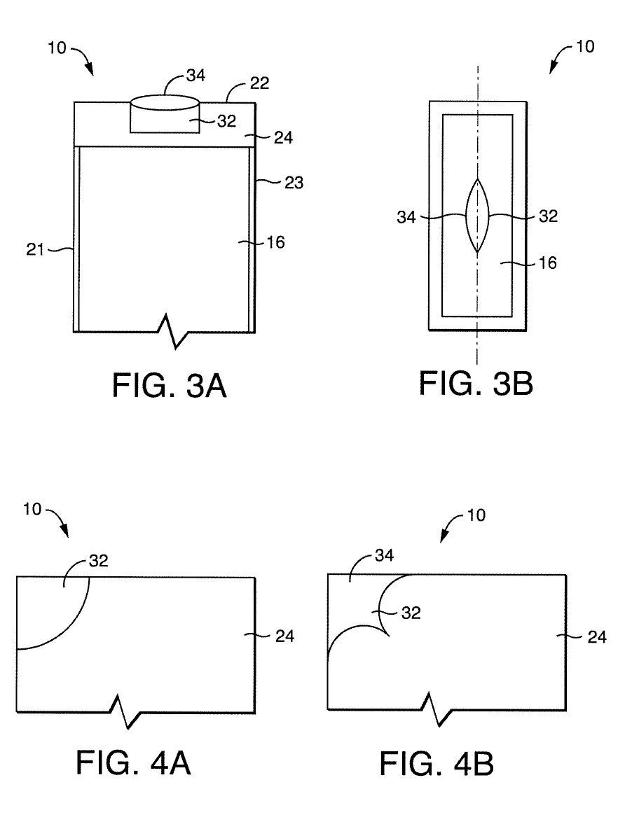

In accordance with the present disclosure, the package 10 shown in FIG. 1 further includes an opening device 30. The opening device 30 as particularly shown in FIGS. 3a and 3b comprises a pair of opposing peel tabs 32 and 34. Peel tabs extend from the tab region 24 to the top edge 22 of the package. As shown in FIGS. 3a and 3b, the peel tabs 32 and 34 form free edges at the top of the package. In this manner, a user can grasp each peel tab and spread them apart thereby peeling the first panel 12 away from the second panel 14 at least within the tab region 24 in order to open the sealed compartment 16.

In the embodiment illustrated in FIGS. 3a and 3b, the package 10 includes a single pair of opposing peel tabs. It should be understood, however, that the package may include multiple pairs of tabs. The peel tabs can be located along a single edge of the package or may be formed into different edges of the package.

The peel tabs 32 and 34 can be formed into the tab region 24 using different methods and techniques. The manner in which the peel tabs are formed, for instance, may depend upon the construction of the peel seal. In one embodiment, for instance, the peel seal may comprise a pressure sensitive adhesive that is printed onto at least one of the panels to form the peel seal. The peel tabs 32 and 34 can thus be formed by not applying the pressure sensitive adhesive to the areas where the tabs are desired.

In an alternative embodiment, a material, such as a coating, may be placed in between the first panel 12 and the second panel 14 within the tab region 24 that prevents a peel seal from forming where the tabs are to be located. For example, referring to FIG. 2, first panel 12 includes a coating or any suitable release medium that defines the peel tab 32. The coating 40, for instance, can be printed onto at least one of the panels. For example, the coating can be applied using an ink jet printer, a flexographic printer, or any other suitable printing device. Alternatively, the coating can be applied by extrusion, spraying, or the like. The coating 40 can be applied to only one panel as shown in FIG. 2 or can be applied to both panels at corresponding locations.

The coating 40 can comprise any suitable material capable of interfering with the formation of the peel seal within the tab region. In one embodiment, for instance, the coating may comprise a silicone.

When the peel seal is formed using any type of thermal bonding, the coating may comprise a material having a softening point or melting temperature that is significantly higher than the polymer materials used to form the peel seal that are thermally bonded together. The material, for instance, may have a softening point or melting temperature that is at least 5 degrees C. higher, such as at least 10 degrees C. higher, such as at least 15 degrees C. higher, such as at least 20 degrees C. higher than the polymers used to form the peel seal.

In one embodiment, the coating 40 applied to one of the panels may have a color that is different than the color of the panels. In this manner, the peel tabs can be made visually apparent to the user to further assist in opening the package. For example, in one embodiment, at least one of the panels 12 or 14 is translucent or transparent and the coating 40 comprises any suitable color that creates a contrast. In other embodiments, the color of the coating 40 can be any suitable different color than the color of the panels. In one embodiment, the coating can be applied to both of the panels so that both of the peel tabs have a color different than the panels.

In addition to interfering with the formation of the peel seal and/or having a distinctive color, the coating 40, in one embodiment, may also cause the first panel 12 and the second panel 14 to separate from each other where the tabs are located. Having the tabs automatically separate from each other can further facilitate opening of the package.

For example, in one embodiment, the coating 40 may cause the film to curl or bow outwards. In this manner, the tabs 32 and 34 separate from each other. The manner in which the film is caused to curl outward may vary depending upon the particular application. In one embodiment, for instance, the coating, once applied to the film, may change the shrink characteristics of the film. Thus, when the film is heated to form the package, the coating may cause the film in the tab region to shrink less than the remainder of the film, which in turn may cause the tab to curl and separate from the opposing film.

The coating 40 may also, in another embodiment, reduce the coefficient of friction of the film and prevent the film from sticking to the opposing film. Using a material with a low coefficient of friction as the coating may also cause the peel tabs to separate.

In the embodiment illustrated in FIGS. 1, 2, 3a and 3b, the peel tabs 32 and 34 generally have a rectangular-like shape. In particular, the peel tabs include four sides. Three of the sides are defined by areas where the first panel 12 is sealed to the second panel 14. The fourth side, however, is located along the edge 22 of the package 10 thereby allowing a user to grab each of the peel tabs and open the package. It should be understood, however, that the peel tabs can have any suitable shape and can be located at any suitable location on the package. Different shapes and configurations, for instance, are shown in FIGS. 4a, 4b, 5, 6 and 7. Like reference numerals have been used to indicate similar elements.

Referring to FIGS. 4a and 4b, for instance, the peel tabs, such as peel tab 32 have a wedge-like shape and are located along a corner of the package. As shown in FIG. 4b, the peel tabs 32 and 34 allow a user to peel the first panel from the second panel within the tab region 24 starting at the corner of the package.

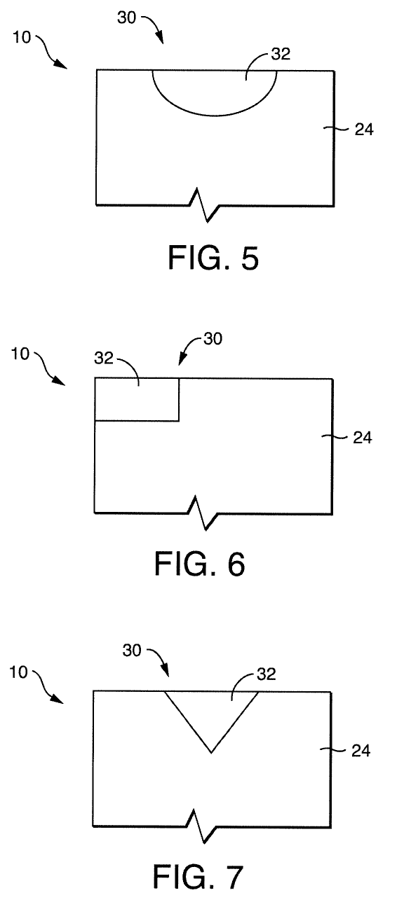

Referring to FIG. 5, a package 10 is shown including a tab region 24 and an opening device 30. The opening device 30 comprises a pair of opposing peel tabs. As shown, peel tab 32, in this embodiment, has a semi-circular-like shape. The peel tab 32 includes a flat or linear portion that is positioned along the open edge of the package.

Referring to FIG. 6, a package 10 is shown in which the peel tab 32 has a rectangular-like shape similar to the peel tabs illustrated in FIG. 1. The peel tab 32 in FIG. 6, however, is located at a corner of the package. Thus, two sides of the peel tab 32 are defined by areas where the first panel 12 is sealed to the second panel 14. The remaining two sides of the peel tab, however, comprise free edges that are located along the edges of the package.

Referring to FIG. 7, still another embodiment of a package 10 made in accordance with the present disclosure is shown. In this embodiment, the opening device 30 includes a pair of opposing peel tabs that have a triangular-like shape. For example, as shown, the peel tab 32 has three sides. Two of the sides are defined by where the first panel 12 is sealed to the second panel 14. The third side of the peel tab, however, comprises an open edge positioned along the top edge of the package.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A package comprising:
a sealed compartment being defined by at least a first panel spaced from a second panel, the sealed compartment including a tab region where the first panel is sealed to the second panel; and
a pair of opposing peel tabs located in the tab region, the peel tabs comprising an area within the tab region where the first panel is not sealed to the second panel, the peel tabs extending from the tab region to an edge of the package; and
wherein a user can peel apart the peel tabs to separate the first panel from the second panel and open the sealed compartment.

2. A package as defined in claim 1, wherein a peel seal is formed between the first panel and the second panel in the tab region.

3. A package as defined in claim 1, wherein a coating is located in between the peel tabs for preventing the first panel from attaching to the second panel where the peel tabs are located.

4. A package as defined in claim 2, wherein a coating is located in between the peel tabs for preventing the first panel from attaching to the second panel where the peel tabs are located.

5. A package as defined in claim 3, wherein the coating comprises a silicone.

6. A package as defined in claim 2, wherein the peel seal comprises a pressure sensitive adhesive located in between the first panel and the second panel.

7. A package as defined in claim 6, wherein the peel seal between the first panel and the second panel comprises the pressure sensitive adhesive located on one of the panels and a release layer located on an opposing panel.

8. A package as defined in claim 2, wherein at least one panel comprises a multi-layer film including a support layer, a pressure sensitive adhesive layer, and a contact layer and wherein the peel seal is formed by thermally bonding the contact layer to the opposing film.

9. A package as defined in claim 2, wherein the peel seal comprises a peel seal composition positioned in between the opposing panels, the opposing panels being thermally bonded together in a manner that allows the panels to be subsequently peeled apart.

10. A package as defined in claim 1, wherein the first panel and the second panel comprise polymer films.

11. A package as defined in claim 1, wherein the peel tabs have a rectangular-like shape that have four sides, and wherein three sides comprise sealed portions and the remaining side comprises the open edge.

12. A package as defined in claim 1, wherein the peel tabs have a rectangular-like shape that have four sides, and wherein two sides comprise sealed portions and the remaining sides comprise the open edges.

13. A package as defined in claim 1, wherein the peel tabs have a semi-circular-like shape and include a flat side that comprises the open edge.

14. A package as defined in claim 1, wherein the peel tabs have a circular-like shape that surrounds a corner of the package.

15. A package as defined in claim 3, wherein the coating has a color that is different than the color of the first panel and the second panel.

16. A package as defined in claim 15, wherein the first panel and the second panel comprise translucent or transparent polymer films.

17. A package as defined in claim 4, wherein the first panel and the second panel comprise polymer films and wherein the coating located between the peel tabs comprises a silicone.

18. A package as defined in claim 3, wherein the coating causes the coated peel tab to curl away from the opposing tab.

19. A process for producing a package comprising:
printing a coating onto a first polymer film at a particular location;
sealing the first polymer film to a second polymer film to form a compartment in between the two films, the polymer films being sealed together to form a tab region, the coating being positioned in the tab region, the coating preventing the first polymer film from sealing to the second polymer film thereby forming opposing peel tabs that extend to an edge of the formed package.

20. A process or method as defined in claim 19, wherein the coating comprises a silicone.

21. A process as defined in claim 19, wherein a peel seal is formed in between the first polymer film and the second polymer film within the tab region.

22. A process as defined in claim 19, wherein the first polymer film and the second polymer film are translucent or transparent and the coating comprises a color.
